(19) United States
(12) Patent Application Publication
(10) Pub. No.: US 2021/0182543 A1
(43) Pub. Date: Jun. 17, 2021

(54) INFRARED SENSING GESTURE RECOGNITION METHOD

(71) Applicant: Wuhan Jielang Environmental Protection Science & Technology Co., Ltd., Wuhan City (CN)

(72) Inventors: Jun Gao, Wuhan City (CN); Yifan Gao, Wuhan City (CN); Ding Jin, Wuhan City (CN)

(73) Assignee: Wuhan Jielang Environmental Protection Science & Technology Co., Ltd.

(21) Appl. No.: 16/714,795

(22) Filed: Dec. 16, 2019

(51) Int. Cl. G06K 9/00; G01N 21/3563

(52) U.S. Cl. CPC G06K 9/00355; G01N 21/3563

(57) ABSTRACT

An infrared sensing gesture recognition method, characterized in that the recognition method adopts multiple infrared light emitting units, and each infrared light emitting unit is loaded with pulse signals on different frequencies, then, one or more infrared receiving units for receiving signals are used to receive infrared reflected signals loaded with corresponding frequencies emitted from different infrared light emitting units, and the infrared reflected signal corresponds to the infrared light emitting unit with the corresponding frequency by identifying the frequency of pulse signal loaded in the infrared reflected signal, so as to determine the physical location of infrared light emitting unit, and to judge the movement trajectory of gesture.

### BACKGROUND OF INVENTION

### 1. Field of the Invention

The present invention relates generally to the technical field of infrared detection, and more particularly to an infrared sensing gesture recognition method.

### 2. Description of Related Art

The infrared sensing generally comprises an infrared source transmitting terminal and an infrared receiving terminal, wherein the infrared source is generally an infrared transmitting tube (e.g. infrared LED). The infrared receiving terminal is an infrared sensor. The wavelength range of the infrared light emitted from the infrared source is 750 nm˜1 mm, it is an invisible light, but it has reflection, refraction and absorption properties as visible light does. The infrared gesture recognition is implemented by using the intensity and energy magnitude of the gesture reflected infrared light detected by infrared sensor according to the physical characteristics of infrared light.

The principle of common infrared sensing gesture recognition based on single light source is that the infrared LED and infrared sensor are placed in the same direction, when a hand covers the infrared LED, the infrared sensor detects a quantity of infrared reflected light, so as to implement gesture recognition by using the intensity and energy magnitude of the gesture reflected infrared light detected by the infrared sensor.

As the infrared light intensity detected by infrared sensor is in functionally inverse relation to the distance from the infrared light reflection surface (hand) to the sensor, and the detection distance and range of infrared sensing are closely related to the viewing angle selection of infrared source. The common infrared source emits conical infrared light, the apex angle of cone is also known as infrared viewing angle. Comparing the infrared sources at different viewing angles, it is easy to observe that the energy is relatively concentrated and the detection range is small in comparison to small viewing angles, but the detection distance is long.

The major deficiencies in the present technical proposals using infrared sensing technique for gesture recognition are low recognition accuracy and large errors. In the course of infrared transmission, the infrared signals are likely to be disturbed by outside signal sources, resulting in errors.

The specification of application for patent of Chinese patent application number 201810603314.9 discloses an infrared gesture recognition device and recognition method, the technical proposal thereof involves an infrared receiving tube, an infrared compensating tube, a driver module, a control module and multiple infrared transmitting tubes integrated on a PCB. The infrared receiving tube, infrared transmitting tube and infrared compensating tube are located on the back side of PCB, and the PCB is provided with corresponding open holes at the infrared receiving tube and infrared transmitting tube for transmitting and receiving infrared on the front side of PCB. The infrared compensating tube emits infrared into the PCB. The technical proposal uses the ratio circuit based on image current source for infrared emission unit and infrared compensating unit, so that internal current of this device has a certain self-regulating power, there is favorable constant current characteristic, so the present invention has favorable temperature stability to remove the disturbance of background light, the adverse effect of ambient light on current infrared gesture module is solved, the reliability and stability are enhanced. However, the technical proposal is unable to solve the problems of low accuracy and limited applicable scenes in current infrared gesture recognition.

For the deficiencies in the existing infrared gesture recognition technique, this inventor proposes the following improvement proposal.

### SUMMARY OF THE INVENTION

The purpose of the present invention is to overcome the problems of the prior art and provide an infrared sensing gesture recognition method.

In order to solve the above technical problems, the present invention adopts the following technical solutions:

An infrared sensing gesture recognition method, characterized in that the recognition method adopts multiple infrared light emitting units, and each infrared light emitting unit is loaded with pulse signals on different frequencies, then, one or more infrared receiving units for receiving signals are used to receive infrared reflected signals loaded with corresponding frequencies emitted from different infrared light emitting units, and the infrared reflected signal corresponds to the infrared light emitting unit with the corresponding frequency by identifying the frequency of pulse signal loaded in the infrared reflected signal, so as to determine the physical location of infrared light emitting unit, and to judge the movement trajectory of gesture.

More particularly, wherein two infrared light emitting units are used and one infrared receiving unit is used.

More particularly, wherein the infrared light emitting units are distributed in an array, the infrared receiving unit is located in a middle of the array distributed infrared light emitting units.

More particularly, wherein the infrared light emitting unit includes an infrared transmitting tube, a signal amplifying circuit and a modulation circuit, the pulse signal on specific frequency is imported through the modulation circuit, and loaded to the infrared transmitting tube through the signal amplifying circuit, so that the infrared transmitting tube emits the infrared signal with the specific frequency.

More particularly, wherein the infrared receiving unit includes an infrared receiving tube, a signal amplifying circuit and a modulation circuit; when the reflected infrared signal is received by the infrared receiving tube, the signal is amplified by the signal amplifying circuit, and then the amplified signal is fed into the demodulation circuit, the corresponding frequency is obtained by demodulation, which infrared emission unit the infrared signal comes from can be determined according to the frequency, so as to implement signal identification.

More particularly, wherein the judgment of movement trajectory of gesture is combined with the following parameters, the time and duration of infrared receiving unit receiving an infrared reflected signal, so as to determine the starting time and duration of a movement trajectory of gesture.

More particularly, wherein the infrared transmitting tube in the infrared light emitting unit is an infrared LED element.

In comparison to the existing technology, the present invention uses multiple infrared emission units, and the infrared signal emitted from each infrared emission unit is loaded with a carrier wave on a specific frequency, thus, the infrared signal emitted from each infrared emission unit is given a specific label. When it is received by the infrared receiving unit, the source of the received reflected infrared signal can be identified to determine the physical location of the infrared light emitting unit, so as to determine the movement trajectory of gesture.

### BRIEF DESCRIPTION OF THE DRAWINGS

FIG. 1 is a schematic diagram of a first embodiment of the present invention;

FIG. 2 is a circuit schematic diagram of an infrared transmitting unit according to the first embodiment of the present invention;

FIG. 3 is a circuit schematic diagram of an infrared receiving unit according to the first embodiment of the present invention;

FIG. 4 is a schematic diagram of a second embodiment of the present invention;

FIG. 5 is a schematic diagram of a third embodiment of the present invention;

FIG. 6 is a schematic diagram of a fourth embodiment of the present invention.

### DETAILED DESCRIPTION OF THE INVENTION

The details of the present invention are described with the figures below.

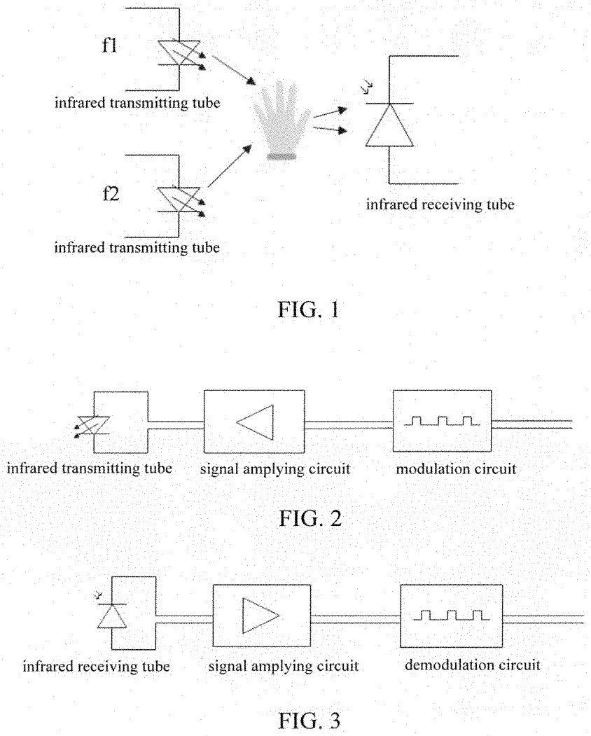

FIG. 1 shows the Embodiment 1 of the present invention, there are two infrared light emitting units in this case, the infrared is emitted usually by infrared transmitting tube. There is one infrared receiving unit, the reflected infrared is received usually by infrared receiving tube. In the infrared emission unit, two infrared transmitting tubes are loaded with different frequency pulses (f1, f2) to emit different infrared signals, the infrared receiving tube detects whether there is a hand or not. If a hand occurs, when the infrared receiving tube receives the infrared signals on frequencies f1 and f2, the infrared signals on different carrier frequencies are identified through circuit, the infrared transmitting tubes in different physical locations are confirmed, the direction of movement of hand is judged according to the time sequence of infrared reflection and infrared emission position.

Certainly, the following parameters are considered in judging the movement trajectory of gesture, the time and duration of infrared receiving unit receiving an infrared reflected signal, so as to determine the starting time and duration of a movement trajectory of gesture. The time parameter is combined with the afore the physical location, the movement direction, travelling speed and stay time of gesture can be judged, so as to implement the judgment and recognition of different gestures.

As shown in FIGS. 2 and 3, in Embodiment 1, the infrared light emitting unit comprises an infrared transmitting tube, a signal amplifying circuit and a modulation circuit, a pulse signal on specific frequency is imported through the modulation circuit, and loaded to the infrared transmitting tube through the signal amplifying circuit, so that the infrared transmitting tube emits infrared signals with the specific frequency. The infrared transmitting tube in the infrared light emitting unit is an infrared LED element.

Further, the infrared receiving unit comprises an infrared receiving tube, a signal amplifying circuit and a modulation circuit. When the reflected infrared signal is received by the infrared receiving tube, the signal is amplified by the signal amplifying circuit, and then the amplified signal is fed into the demodulation circuit, the corresponding frequency is obtained by demodulation, which infrared emission unit the infrared signal comes from can be determined according to the frequency, so as to implement signal identification.

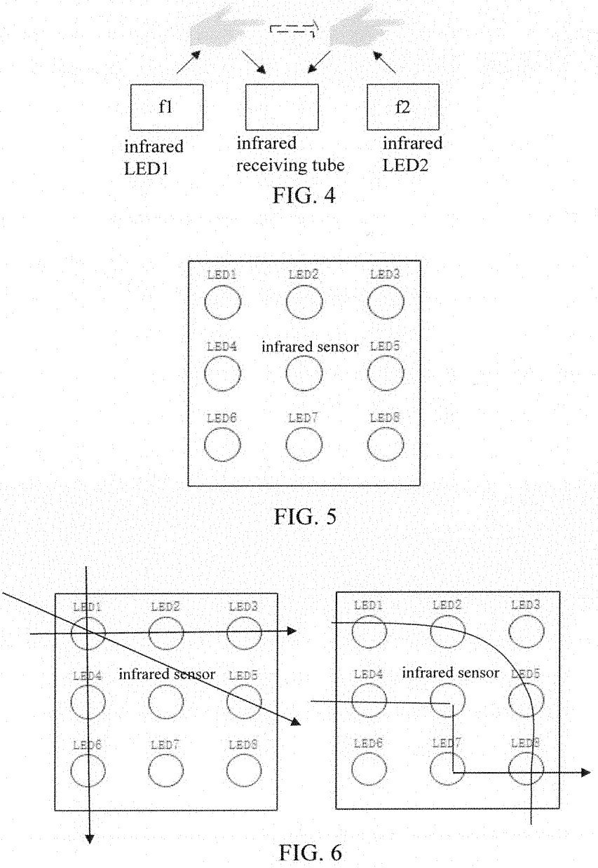

FIG. 4 shows Embodiment 2 of the present invention, two infrared light emitting units coordinate with one infrared receiving unit in this case to describe the operating principle. First of all, the infrared LED in the two infrared light emitting units is loaded with pulses on different frequencies (f1 and f2) to emit the corresponding infrared signals. When the hand moves from left to right above, the hand first reflects the infrared signal on frequency f1. When the infrared receiving tube in the infrared receiving unit receives the signal, the signal on frequency f1 is identified first. When the hand moves somewhere about the infrared LED2 light source, the infrared signal on frequency f2 is reflected, and then the signal on frequency f2 is identified by circuit, the left to right movement of hand can be judged by judging different frequencies and the occurrence time sequence. When the hand moves from right to left, the principle is similar. Certainly, more infrared light emitting units and infrared receiving units are allowed.

FIG. 5 shows Embodiment 3 of the present invention, the infrared light emitting units are distributed in array in this case, the infrared receiving unit is located in the middle of the infrared light emitting units distributed in array. In this embodiment, the infrared transmitting tube in the infrared light emitting unit is infrared LED element, and the infrared receiving tube in the infrared receiving unit is an infrared sensor. The LED element and infrared sensor are directly integrated into the circuit board.

The array distributed infrared light emitting units in this case can implement the hand in different directions (up-down movement, left-right movement) and more complex (rotation, hovering) multi-trajectory direction of movement. The operating principle is that the infrared LED1-LED8 are loaded with pulse signals on frequencies f1-f8, when the hand is moving above, the infrared sensor receives signals, which are identified to determine the movement direction of hand. The effective area of matrix gesture recognition is enlarged by increasing the number of infrared sources (n, n shall not be smaller than 3). Therefore, more complex gestures can be identified, at least 2n (n is the number of infrared sources, n shall not be smaller than 3) gestures can be identified, applicable to more scenes.

As shown in FIG. 6, the array distributed infrared light emitting units can implement different gestures.
LED1->LED2->LED3, LED1->LED4->LED6, LED1->LED5, implementing linear detection of gesture;
LED1->LED2->LED5->LED8, implementing gesture rotation detection;
LED1->LED7->LED8, implementing gesture turning detection.

As stated above, when the time parameter is applied, more complex hovering detection can be implemented.

The embodiments of the present invention do not limit the scope of the present invention, any equivalent changes or modifications according to the structure and method of the present invention shall be covered within the scope of the present invention.

We claim:

1. An infrared sensing gesture recognition method, characterized in that the recognition method adopts multiple infrared light emitting units, and each infrared light emitting unit is loaded with pulse signals on different frequencies, then, one or more infrared receiving units for receiving signals are used to receive infrared reflected signals loaded with corresponding frequencies emitted from different infrared light emitting units, and the infrared reflected signal corresponds to the infrared light emitting unit with the corresponding frequency by identifying the frequency of pulse signal loaded in the infrared reflected signal, so as to determine the physical location of infrared light emitting unit, and to judge the movement trajectory of gesture.

2. The infrared sensing gesture recognition method according to claim 1, wherein two infrared light emitting units are used and one infrared receiving unit is used.

3. The infrared sensing gesture recognition method according to claim 1, wherein the infrared light emitting units are distributed in an array, the infrared receiving unit is located in a middle of the array distributed infrared light emitting units.

4. The infrared sensing gesture recognition method according to claim 1, wherein the infrared light emitting unit includes an infrared transmitting tube, a signal amplifying circuit and a modulation circuit, the pulse signal on specific frequency is imported through the modulation circuit, and loaded to the infrared transmitting tube through the signal amplifying circuit, so that the infrared transmitting tube emits the infrared signal with the specific frequency.

5. The infrared sensing gesture recognition method according to claim 1, wherein the infrared receiving unit includes an infrared receiving tube, a signal amplifying circuit and a modulation circuit; when the reflected infrared signal is received by the infrared receiving tube, the signal is amplified by the signal amplifying circuit, and then the amplified signal is fed into the demodulation circuit, the corresponding frequency is obtained by demodulation, which infrared emission unit the infrared signal comes from can be determined according to the frequency, so as to implement signal identification.

6. The infrared sensing gesture recognition method according to claim 1, wherein the judgment of movement trajectory of gesture is combined with the following parameters, the time and duration of infrared receiving unit receiving an infrared reflected signal, so as to determine the starting time and duration of a movement trajectory of gesture.

7. The infrared sensing gesture recognition method according to claim 4, wherein the infrared transmitting tube in the infrared light emitting unit is an infrared LED element.
